(19) United States
(12) Patent Application Publication
(10) Pub. No.: US 2005/0239644 A1
(43) Pub. Date: Oct. 27, 2005

(54) Method of making photocatalysts by loading titanuim dioxide film on flexible substrates

(75) Inventors: Yongfa Zhu, Beijing (CN); Yu He, Beijing (CN); Fang Yu, Beijing (CN)

Correspondence Address: FOLEY AND LARDNER;SUITE 500, 3000 K STREET NW, WASHINGTON, DC, 20007, US

(73) Assignee: TSINGHUA UNIVERSITY

(21) Appl. No.: 10/520,846

(22) PCT Filed: Jul. 11, 2003
(86) PCT No.: PCT/CN03/00553

§ 371 Date: Jan. 11, 2005

(30) Foreign Application Priority Data
Jul. 12, 2002 (CN) 02124137.6

(51) Int. Cl. B01J 23/00

(52) U.S. Cl. 502/350

(57) ABSTRACT

Disclosed are methods of making a photocatalyst by loading titanium dioxide film on a flexible substrate, comprising the steps of: (1) Preparing an active layer sol-gel by: (a) Making a precursor solution comprising n-butyl titanate, ethanol, diethanolamine, and water; (b) Adding a pore-forming agent selected from the group consisting of polyglycol, octadecylamine, and mixtures thereof to the precursor solution; and (c) Placing the resulting solution in a sealed gelatinization process for at least 3 days; and (2) Preparing an active TiO₂ photocatalyst layer by: (a) Coating a flexible substrate with the active layer sol-gel prepared according to step (1) using a pulling and coating process; (b) Drying the coated flexible substrate; and (c) Placing the coated, dried flexible substrate in a hydrothermal kettle for thermal crystallization in a mixed solvent of ethanol and water at 60-200° C. Further disclosed are methods wherein the precursor solution comprises titanium tetrachloride, ethanol, and water.

### FIELD OF THE INVENTION

The present invention relates to a method of making photocatalysts, especially a method of making photocatalysts by loading titanium dioxide film on a flexible substrate, and the photocatalyst made thereby.

### BACKGROUND OF THE INVENTION

At present, there are essentially three known methods for manufacturing surface-load titanium dioxide (TiO₂) photocatalysts: (1) using sol-gels to form a TiO₂ film directly on the substrate and undergoing high-temperature calcination; (2) dispersing nano-powder in a suspension solution, loading it onto the substrate, and undergoing high-temperature calcination; and (3) using inorganic or organic gels to load nano photocatalysts onto metal screens. The TiO₂ photocatalytic films manufactured by sol-gel process of the method (1) have no pores, small specific surface areas, and low activity. In addition, the calcination temperature is usually over 400° C., so the substrate must be resistant to high temperatures. The photocatalytic films manufactured according to the method (2) tend to peel off easily because the bonding between the secondary powder and the substrate is weak. Consequently, this method is of little practical value. The photocatalytic effectiveness of the catalyst manufactured according to the method (3) is reduced because the catalytic films are wrapped up by inorganic or organic sol-gels. The bonding between the films and the substrates is weak. In addition, organic sol-gels are likely to have UV decomposition.

The aforementioned methods usually employ sheet materials (such as metal plates and glass plates) or glass beads as photocatalytic supports. The photocatalysts thus manufactured have some shortcomings, such as limited areas of effective light exposure, limited areas of contact between photocatalysts and fluids, and great air resistance unfavorable for high flow rate reaction. In addition, the substrate materials are likely to diffuse into the photocatalysts, thus reducing the activity of the photocatalysts and making it hard to form active crystalline phase structures. Photocatalysts currently available generally employ honeycomb ceramics as supports to overcome the disadvantages of sheet or pellet supports in applications. Ceramic supports, however, have disadvantages, too. First, they are expensive in cost and weak in mechanical strength, hence easy to break. Second, due to their rigidity, it is hard to manufacture ceramic photocatalytic components of specific structures or shapes. Third, the required manufacturing technology is so sophisticated that it is hard to produce large supports.

Chinese patent application numbers 01141902.4 and 01131093.6 disclose surface-load medium-size pore TiO₂ nano films on substrates of glass beads and metal screens by sol-gel processes of spinning off excessive sol-gel and high temperature calcination. The substrates disclosed in these references are readily available and low in cost. The photocatalysts so manufactured are believed to have strong bonding strength, be easy to manufacture, versatile in application, and highly effective. However, as these manufacturing processes require a temperature of 350-550° C., they are not suitable for non-woven fabrics, woven fabrics, dust-free paper and other flexible substrate materials that are not resistant to high temperatures.

Thus there remains a need for low temperature methods by which photocatalytic substrates can be made from flexible substrate materials such as non-woven fabrics, woven fabrics, dust-free paper and other flexible substrate materials that are not resistant to high temperatures. The present invention provides such methods.

### SUMMARY OF THE INVENTION

The present invention relates to methods of making a photocatalyst by loading titanium dioxide film on a flexible substrate, comprising the steps of: (1) Preparing an active layer sol-gel by: (a) Making a precursor solution comprising n-butyl titanate, ethanol, diethanolamine, and water; (b) Adding a pore-forming agent selected from the group consisting of polyglycol, octadecylamine, and mixtures thereof to the precursor solution; and (c) Placing the resulting solution in a sealed gelatinization process for at least 3 days; and (2) Preparing an active TiO₂ photocatalyst layer by: (a) Coating a flexible substrate with the active layer sol-gel prepared according to step (1) using a pulling and coating process; (b) Drying the coated flexible substrate; and (c) Placing the coated, dried flexible substrate in a hydrothermal kettle for thermal crystallization in a mixed solvent of ethanol and water at 60-200° C. The present invention further relates to methods wherein the precursor solution comprises titanium tetrachloride, ethanol, and water.

### DETAILED DESCRIPTION OF THE INVENTION

The present invention relates to methods of making flexible substrate surface-load titanium dioxide nanocrystalline film photocatalysts. Flexible material supports provide improved effectiveness of light utilization, increase the effective action areas among the light, the photocatalyst and the fluids, and expand the applications of the photocatalysts. Flexible substrate materials are easy to obtain and low in cost. In addition, the methods according to the present invention utilize a thermo-solvent process to form active anatase structures at low temperatures. Therefore, non-woven fabrics, woven fabrics, dust-free fabrics, and other flexible substrate materials that are not resistant to high temperatures can be used, providing reduced cost and expanding the practical applications of the photocatalytic substrates herein.

The present invention further relates to photocatalysts manufactured according to the above methods.

The term “pulling and coating method”, as used herein, means to pull the photocatalysts impregnated in sol-gels out of the sol-gels by using a pull apparatus. Excess portions of the sol-gels automatically fall back into the vessel containing the sol-gels under the action of gravity. Portions of the sol-gels absorb on the surface of supports and form a compact film layer. The thickness of the film is controlled via pulling speed, concentrate and viscosity of sol-gels so as to control the thickness of sol-gel film loaded on the supports and the thickness of photocatalyst layer formed.

The term “solvent thermal crystallization”, as used herein, means that certain chemical products or materials are dissolved or dispersed in solvents (such as alcohol, water) and heat treated under a sealed conditions so that the temperature and pressure in a container are increased. When the pressure in the container is over 1 atmospheric pressure, it can promote the chemical reactions or the formation of crystalline states that are difficult to be carried out under normal pressure, and achieve the object of forming crystalline phase under non-high temperature.

A preferred method of making flexible substrate surface-load titanium dioxide nanocrystalline film photocatalysts according to the present invention comprises the steps of: (1) Preparation of an active layer sol-gel; and (2) Preparation of an active photocatalyst layer. Each step is described in detail below.

(1) Preparation of an Active Layer Sol-Gel

A precursor solution is prepared as follows. Preferred precursors suitable for use in the present invention are n-butyl titanate and titanium tetrachloride, and mixtures thereof.

Using n-butyl titanate as a precursor, a precursor solution in the volume ratio of n-butyl titanate:ethanol:diethanolamine:water=1:8-12:0.1-0.15:0.05-0.06 is prepared. The preferred addition sequence is: water is added to ethanol solution, then diethanolamine as a stabilizing agent is added to the solution, n-butyl titanate solution is then added to the mixed solution to give a yellowish homogeneous clear solution, and then an organic additive as a pore-forming agent is added to the solution. Preferred pore-forming agents are polyglycol, octadecylamine, and mixtures thereof. The mass ratio of the amount of the pore-forming agent to the amount of the ethanol in the precursor solution is pore-forming agent:ethanol=1% to 30%, preferably, 8% to 15%. The solution is placed in a sealed condition for at least 3 days, preferably from about 3 to about 7 days, to gelatinize, and a clear sol-gel is obtained.

Using titanium tetrachloride as a precursor, a precursor solution in the volume ratio of titanium tetrachloride:ethanol:water=1:8-12:0.08-0.15 is prepared. The addition preferred sequence is: water is added to ethanol solution, then titanium tetrachloride is added to the solution to form a yellowish clear solution, and then an organic additive as a pore-forming agent is added to the solution. Preferred pore-forming agents are polyglycol, octadecylamine, and mixtures thereof. The mass ratio of the amount of the pore-forming agent to the amount of the ethanol in the precursor solution is pore-forming agent:ethanol=1%-30%, preferably, 8-15%. The solution is placed in a sealed condition for at least 3 days, preferably from about 3 to about 7 days, and a clear sol-gel having a certain viscosity is obtained.

According to another preferred embodiment of the present invention, in the preparation of active layer sol-gel, an additional agent selected from lanthanum nitrate, n-butyl silicate, and mixtures thereof, can be further added to the precursor solution at any time. The molar ratio of La to Ti is from 0% to about 5%, preferably from about 0.8% to about 1.2%; the molar ratio of Si to Ti is from 0% to about 40%, preferably from about 15% to about 25%. The action of lanthanum nitrate is believed to control the growth of TiO₂ nanocrystal so as to make the particle size of TiO₂ crystal at about 10-15 nm. The addition of n-butyl silicate is to form partial SiO₂ sol-gel in the TiO₂ sol-gel so as to control the growth of TiO₂ crystal and to increase the specific surface area of the photocatalysts.

(2) Preparation of an Active Photocatalyst Layer

The active layer sol-gel prepared according to step (1) is directly coated on a cleaned flexible substrate by pulling and coating method. Excess sol-gel is removed. The thickness of the sol-gel layer is controlled by adjusting the viscosity of the sol-gel and the number of pulling iterations. The resulting wet sol-gel film is dried and then placed in a hydrothermal kettle for thermal crystallization in a mixed solvent of ethanol and water preferably at a volume ratio of ethanol to water of 0-100% at 60-200° C., preferably for at least about 2 hours. To ensure the evenness and activity of TiO₂ film, the film is pulled one to four times, preferably 2-3 times.

According to another preferred embodiment of the present invention, in the preparation step of active photocatalyst layer, said excess sol-gel is removed by spinning or extrusion; said wet sol-gel film is dried preferably at 30-150° C., more preferably at 80-120° C.

According to still another preferred embodiment of the present invention, in the preparation step of active photocatalyst layer, the ratio (by volume) of ethanol to water in the mixed solvent of ethanol-water for solvent thermal crystallization is preferably from 0% to about 80%, most preferably from 0% to about 20%; the temperature of solvent thermal crystallization is preferably from 120-140° C.

It should be noted that the temperature of solvent thermal crystallization has a great effect on the performance of the catalysts obtained. When the temperature is lower than 60° C., it is difficult to form a perfect TiO₂ crystal structure and its activity is very low; contrarily, when the temperature is higher than 200° C., the flexible substrate may be sintered, carbonized or decomposed so that the structure of flexible substrate is destroyed. Therefore, it is necessary to select suitable solvent heat treatment temperature.

In the method of the present invention, the flexible substrate materials include non-woven fabrics, woven fabrics, dust-free paper, most preferably water-pricked non-woven fabrics which surfaces have strong hydrophilic property.

The flexible substrate TiO₂ nanocrystalline photocatalysts manufactured according to the methods of the present invention have advantages of strong bonding strength, small gas resistance, high photocatalytic effectiveness and high activity. Throughout the entire preparation method, the raw materials used are low in cost, the processes are relatively simple, and the preparation temperatures are low; therefore, the production cost is effectively reduced. It is believed that the present invention has much practical value and application prospects.

### BRIEF DESCRIPTION OF THE DRAWINGS

FIG. 1 is a SEM photograph of the combined state of the catalyst film of Example 1; and

FIG. 2 is a SEM photograph of the combined state of the catalyst film of Example 2.

### EXAMPLES

The following examples further describe and demonstrate embodiments within the scope of the present invention. These examples are given solely for the purpose of illustration and are not to be construed as limitations of the present invention as many variations thereof are possible without departing from the spirit and scope.

In the following examples, the precursor (preferably titanium tetrachloride or n-butyl titanate), the pore-forming agent (preferably polyglycol or octadecylamine), solvent (preferably ethanol) and stabilizing agent (preferably diethanolamine) are commercially analytic pure or chemical pure products. The flexible substrate materials used are non-woven fabrics, woven fabrics, and dust-free paper.

The photocatalytic performance of the catalysts obtained is evaluated via the following method: Photocatalytic reaction apparatus is comprised of a sleeve-type internal and external cylinder. A 8 W ultraviolet lamp at a wavelength of 254 nm is installed in the internal sleeve. The internal sleeve is wrapped with a layer of flexible photacatalyst coating with TiO₂ photocatalyst, The average distance of the photcatalyst and the ultraviolet light source is 3 cm; its receiving light area is 112 cm². A certain concentrate of formaldehyde gas is entered from the internal slip and flowed out through a silk screen. The amount of formaldehyde in the outflow gas is determined by using gas chromatograph with a hydrogen flame detector.

### Example 1

(1) Preparation of the Active Layer Sol-gel: Using titanium tetrachloride as a precursor agent, prepare the precursor solution in the volume ratio of titanium tetrachloride:ethanol:water=1:10:0.12. The addition sequence is as follows: first add water to the ethanol solution, then drip feed the titanium tetrachloride to produce a yellowish clear solution, and finally add 10% PEG400 (polyethylene glycol, molecular weight 400). Place the mixed solution in a sealed gelatinization process for 3 days and the resultant product is a yellowish clear sol-gel of a certain viscosity.

(2) Preparation of the Active Photocatalyst Layer: At room temperature, wash a piece of non-woven fabric with a cleaning agent, and then immerse the material in the active layer sol-gel prepared in step (1). After immersion for 1 minute, take the non-woven fabric out, use a high-speed centrifugal spinner to spin off the sol-gel on its surface, and then let it air-dry. Re-immerse the non-woven fabric in the active layer sol-gel, take it out after 1 minute and spin off the sol-gel on its surface, and then let it air-dry. Repeat this procedure until the non-woven fabric has had four active layers loaded on its surface. Finally, place the non-woven fabric coated with wet TiO₂ sol-gel into a hydrothermal kettle with water as the solvent, heat the kettle to 110° C., keep at this temperature for 2 hours, take the fabric out, and then wash and oven-dry. The resultant product is a non-woven fiber substrate surface-load titanium dioxide film photocatalyst.

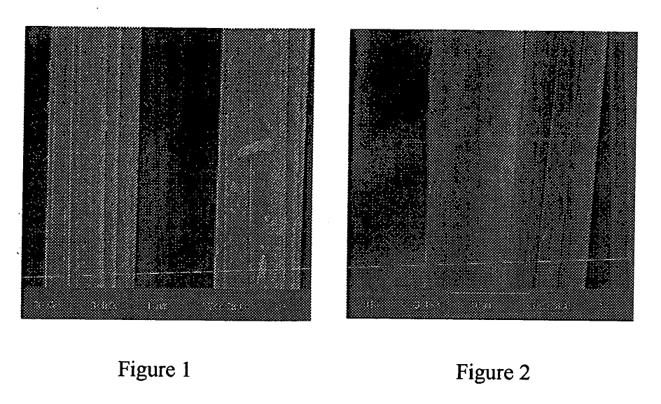

An electronic microscopic study (see FIG. 1) has revealed that this photocatalytic film has strong bonding strength. A photocatalytic property evaluation study has shown that the photocatalyst has high catalytic activity and is capable of reducing the concentration of a formaldehyde gas from 900 ppm to 610 ppm at the reaction flow rate of 160 ml/min with an 8 W UV lamp as the light source mainly of the 254 nm wavelength.

### Example 2

(1) Preparation of the Active Layer Sol-gel: Using titanium tetrachloride as a precursor agent, prepare the precursor solution in the volume ratio of titanium tetrachloride:ethanol:water=1:12:0.15. The addition sequence is as follows: first add water to the ethanol solution, then drip feed the titanium tetrachloride to produce a yellowish clear solution, and finally add 15% PEG400. Place the mixed solution in a sealed gelatinization process for 5 days and the resultant product is a yellowish clear sol-gel of a certain viscosity.

(2) Preparation of the Active Photocatalyst Layer: At room temperature, wash a piece of non-woven fabric with a cleaning agent, and then immerse the material in the active layer sol-gel prepared according to step (1). After immersion for 2 minutes, take the non-woven fabric out, use a high-speed centrifugal spinner to spin off the sol-gel on its surface, and then let it air-dry. Re-immerse the non-woven fabric in the active layer sol-gel, take it out after 2 minutes and spin off the sol-gel on its surface, and then let it air-dry. Now the non-woven fabric has had two active layers loaded on its surface. Finally, place the non-woven fabric coated with wet TiO₂ sol-gel into a hydrothermal kettle with a mixed solvent of water and ethanol (volume ratio 1:1), heat the kettle to 140° C., keep at this temperature for 4 hours, take the fabric out, and then wash and oven-dry. The resultant product is a non-woven fabric substrate surface-load titanium dioxide film photocatalyst.

An electronic microscopic study (see FIG. 2) has revealed that the photocatalytic film has strong bonding strength. A photocatalytic property evaluation study has shown that the photocatalyst has high catalytic activity and is capable of reducing the concentration of a formaldehyde gas from 900 ppm to 360 ppm at the reaction flow rate of 160 ml/min with an 8 W UV lamp as the light source mainly of the 254 nm wavelength.

### Example 3

(1) Preparation of the Active Layer Sol-gel: Using n-butyl titanate as a precursor agent, prepare the solution in the volume ratio of n-butyl titanate:ethanol:diethanolamine:water=1:10:0.12:0.06. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 20% PEG400 as a pore-forming agent to the solution. Place the mixed solution in a sealed gelatinization process for 7 days and the resultant product is a clear sol-gel of a certain viscosity.

(2) Preparation of the Active Photocatalyst Layer: At room temperature, wash a piece of non-woven fabric with a cleaning agent, and then immerse the material in the aforementioned active layer sol-gel. After immersion for 1 minute, take the non-woven fabric out, use a high-speed centrifugal spinner to spin off the sol-gel on its surface, and then let it air-dry. Re-immerse the non-woven fabric in the active layer sol-gel, take it out after 1 minute and spin off the sol-gel on its surface, and then let it air-dry. Repeat this procedure until the non-woven fabric has had three active layers loaded on its surface. Finally, place the non-woven fabric coated with wet TiO₂ sol-gel into a hydrothermal kettle with ethanol as the solvent, heat the kettle to 130° C., keep at this temperature for 2 hours, take the fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 900 ppm to 450 ppm at the reaction flow rate of 160 ml/min with an 8 W UV lamp as the light source mainly of the 254 nm wavelength.

### Example 4

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 8% PEG400 as a pore-forming agent to the solution. Place the mixed solution in a sealed gelatinization process for 7 days and the resultant product is a clear sol-gel of a certain viscosity.

(2) Preparation of the Active Photocatalyst Layer: At room temperature, wash a piece of dust-free paper with a cleaning agent, and then immerse the material in the aforementioned active layer sol-gel. After immersion for 1 minute, take the dust-free paper out, use a high-speed centrifugal spinner to spin off the sol-gel on its surface, and then let it air-dry. Re-immerse the dust-free paper in the active layer sol-gel, take it out after 1 minute and spin off the sol-gel on its surface, and then let it air-dry. Now the dust-free paper has had two active layers loaded on its surface. Finally, place the dust-free paper coated with wet TiO₂ sol-gel into a hydrothermal kettle with ethanol as the solvent, heat the kettle to 120° C., keep at this temperature for 4 hours, take the paper out, and then wash and oven-dry. The resultant product is a dust-free paper substrate surface-load titanium dioxide film photocatalyst.

A photocatalytic property evaluation study has shown that the photocatalyst has high catalytic activity and is capable of reducing the concentration of a formaldehyde gas from 900 ppm to 560 ppm at the reaction flow rate of 160 ml/min with an 8 W UV lamp as the light source mainly of the 254 nm wavelength.

### Example 5

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% PEG400 as a pore-forming agent to the solution. Place the mixed solution in a sealed gelatinization process for 5 days and the resultant product is a clear sol-gel of a certain viscosity.

(2) Preparation of the Active Photocatalyst Layer: At room temperature, wash a piece of woven fabric with a cleaning agent, and then immerse the material in the aforementioned active layer sol-gel. After immersion for 1 minute, take the woven fabric out, use a high-speed centrifugal spinner to spin off the sol-gel on its surface, and then let it air-dry. Re-immerse the woven fabric in the active layer sol-gel, take it out after 1 minute and spin off the sol-gel on its surface, and then let it air-dry. Now the woven fabric has had two active layers loaded on its surface. Finally, place the woven fabric coated with wet TiO₂ sol-gel into a hydrothermal kettle with ethanol as the solvent, heat the kettle to 140° C., keep at this temperature for 3 hours, take the fabric out, and then wash and oven-dry. The resultant product is a woven fabric substrate surface-load titanium dioxide film photocatalyst.

A photocatalytic property evaluation study has shown that the photocatalyst has high catalytic activity and is capable of reducing the concentration of a formaldehyde gas from 900 ppm to 380 ppm at the reaction flow rate of 160 ml/min with an 8 W UV lamp as the light source mainly of the 254 nm wavelength.

### Example 6

(1) Preparation of the Active Layer Sol-gel: Using n-butyl titanate as a precursor agent, prepare the precursor solution in the volume ratio of n-butyl titanate:ethanol:diethanolamine:water=1:8:10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% PEG800 as a pore-forming agent to the solution. Place the mixed solution in a sealed gelatinization process for 5 days and the resultant product is a clear sol-gel of a certain viscosity.

(2) Preparation of the Active Photocatalyst Layer: At the room temperature, wash a piece of woven fabric with a cleaning agent, and then immerse the material in the aforementioned active layer sol-gel. After immersion for 1 minute, take the woven fabric out, use a high-speed centrifugal spinner to spin off the sol-gel on its surface, and then let it air-dry. Re-immerse the woven fabric in the active layer sol-gel, take it out after 1 minute and spin off the sol-gel on its surface, and then let it air-dry. Now the woven fabric has had two active layers loaded on its surface. Finally, place the woven fabric coated with wet TiO₂ sol-gel into a hydrothermal kettle with ethanol as the solvent, heat the kettle to 140° C., keep at this temperature for 3 hours, take the fabric out, and then wash and oven-dry. The resultant product is a woven fabric substrate surface-load titanium dioxide film photocatalyst.

A photocatalytic property evaluation study has shown that the photocatalyst has high catalytic activity and is capable of reducing the concentration of a formaldehyde gas from 1000 ppm to 100 ppm at the reaction flow rate of 160 ml/min with an 8 W UV lamp as the light source mainly of the 254 nm wavelength.

### Example 7

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% PEG800 as a pore-forming agent to the solution. Place the mixed solution in a sealed gelatinization process for 5 days and the resultant product is a clear sol-gel of a certain viscosity.

(2) Preparation of the Active Photocatalyst Layer: At room temperature, wash and dry a piece of water-pricked non-woven fabric, and then immerse the material in the aforementioned active layer sol-gel. After immersion for 1 minute, take the non-woven fabric out, remove the excess sol-gel from its surface by extrusion, and then oven-dry it with 60° C. air flows. Repeat the procedure until the non-woven fabric has had two active layers loaded on its surface. Finally, place the non-woven fabric coated with wet TiO₂ sol-gel into a hydrothermal kettle with water as the solvent, heat the kettle to 130° C., keep at this temperature for 2 hours, take the non-woven fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 2000 ppm to 100 ppm at the reaction flow rate of 160 ml/min with an 8 W UV lamp as the light source mainly of the 254 nm wavelength.

### Example 8

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, finally add 10% PEG800 as a pore-forming agent and lanthanum nitrate with the La/Ti molar ratio at 1%. Place the mixed solution in a sealed gelatinization process for 5 days and the resultant product is a clear sol-gel of a certain viscosity.

(2) Preparation of the Active Photocatalyst Layer: At room temperature, wash and dry a piece of non-woven fabric, and then immerse the material in the aforementioned active layer sol-gel. After immersion for 1 minute, take the non-woven fabric out, remove the excess sol-gel from its surface by extrusion, and then oven-dry it with 60° C. air flows. Repeat the procedure until the non-woven fabric has had two active layers loaded on its surface. Finally, place the non-woven fabric coated with wet TiO₂ sol-gel into a hydrothermal kettle with water as the solvent, heat the kettle to 130° C., keep at this temperature for 2 hours, take the non-woven fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 3000 ppm to 50 ppm at the reaction flow rate of 160 ml/min with an 8 W UV lamp as the light source mainly of the 254 nm wavelength.

### Example 9

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% PEG800 as a pore-forming agent and n-butyl silicate with the Si/Ti mole ratio of 15% to the solution. Place the mixed solution in a sealed gelatinization process for 5 days and the resultant product is a clear sol-gel of a certain viscosity.

(2) Preparation of the Active Photocatalyst Layer: At room temperature, wash and dry a piece of non-woven fabric, and then immerse the material in the aforementioned active layer sol-gel. After immersion for 1 minute, take the non-woven fabric out, remove the excess sol-gel from its surface by extrusion, and then oven-dry it with 60° C. air flows. Repeat the procedure until the non-woven fabric has had two active layers loaded on its surface. Finally, place the non-woven fabric coated with wet TiO₂ sol-gel into a hydrothermal kettle with water as the solvent, heat the kettle to 130° C., keep at this temperature for 2 hours, take the non-woven fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 3500 ppm to less than 50 ppm at the reaction flow rate of 160 ml/min with an 8 W UV lamp as the light source mainly of the 254 nm wavelength.

### Example 10

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% PEG800 as a pore-forming agent, and lanthanum nitrate with the La/Ti molar ratio at 1% and n-butyl silicate with the Si/Ti mole ratio at 20% to the solution. Place the mixed solution place in a sealed gelatinization process for 5 days and the resultant product is a clear sol-gel of a certain viscosity.

(2) Preparation of the Active Photocatalyst Layer: At room temperature, wash and dry a piece of non-woven fabric, and then immerse the material in the aforementioned active layer sol-gel. After immersion for 1 minute, take the non-woven fabric out, remove the excess sol-gel from its surface by extrusion, and then oven-dry it with 60° C. air flows. Repeat the procedure until the non-woven fabric has had two active layers loaded on its surface. Finally, place the non-woven fabric coated with wet TiO₂ sol-gel into a hydrothermal kettle with water as the solvent, heat the kettle to 126° C., keep the temperature for 2 hours, take the non-woven fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 500 ppm to less than 250 ppm within 2 hours in a static reactor which has a volume of 500 ml and a catalyst area of 10 cm² and uses natural sunlight as the light source for the reaction.

### Example 11

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% PEG800 as a pore-forming agent to the solution. Place the mixed solution in a sealed gelatinization process for 5 days and the resultant product is a clear sol-gel of a certain viscosity.

(2) Preparation of the Active Photocatalyst Layer: At room temperature, wash a piece of non-woven fabric with a cleaning agent, and then immerse the material in the active layer sol-gel prepared according to step (1). After immersion for 1 minute, take the non-woven fabric out, use a high-speed centrifugal spinner to spin off the sol-gel on its surface, and then let it air-dry. Re-immerse the non-woven fabric in the active layer sol-gel, take it out after 1 minute and spin off the sol-gel on its surface, and then let it dry at 90° C. Now the non-woven fabric has had two active layers loaded on its surface. Finally, place the non-woven fabric coated with wet TiO₂ sol-gel into a hydrothermal kettle with a mixed solvent of 50% water and 50% ethanol (volume ratio), heat the kettle to 90° C., keep at this temperature for 3 hours, take the fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 1000 ppm to 300 ppm at the reaction flow rate of 160 ml/min with an 8 W UV lamp as the light source mainly of the 254 nm wavelength.

### Example 12

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% octadecylamine as a pore-forming agent to the solution. Place the mixed solution place in a sealed gelatinization process for 5 days and the resultant product is a clear sol-gel of a certain viscosity.

(2) Preparation of the Active Photocatalyst Layer: At room temperature, wash a piece of non-woven fabric with a cleaning agent, and then immerse the material in the active layer sol-gel prepared according to step (1). After immersion for 1 minute, take the non-woven fabric out, use a high-speed centrifugal spinner to spin off the sol-gel on its surface, and then let it air-dry. Re-immerse the non-woven fabric in the active layer sol-gel, take it out after 1 minute and spin off the sol-gel on its surface, and then let it dry at 90° C. Now the non-woven fabric has had two active layers loaded on its surface. Finally, place the non-woven fabric coated with wet TiO₂ sol-gel into a hydrothermal kettle with a mixed solvent of 80% water and 20% ethanol (volume ratio), heat the kettle to 130° C., keep at this temperature for 3 hours, take the fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 1000 ppm to 500 ppm at the reaction flow rate of 160 ml/min with an 8 W UV lamp as the light source mainly of the 254 nm wavelength.

### Example 13

(1) Preparation of the Active Layer Sol-gel: Using n-butyl titanate as a precursor agent, prepare the precursor solution in the volume ratio of n-butyl titanate:ethanol:diethanolamine:water=1:8:0.10:0.05. The addition sequence is as follows: first add water to the ethanol solution, then add diethanolamine as a stabilizing agent, then drip feed the n-butyl titanate solution into the aforementioned mixed solution to produce a yellowish homogeneous clear solution, and finally add 10% PEG800 as a pore-forming agent to the solution. Place the mixed solution in a sealed gelatinization process for 5 days and the resultant product is a clear sol-gel of a certain viscosity.

(2) Preparation of the Active Photocatalyst Layer: At room temperature, wash a piece of non-woven fabric with a cleaning agent, and then immerse the material in the active layer sol-gel prepared according to step (1). After immersion for 1 minute, take the non-woven fabric out, use a high-speed centrifugal spinner to spin off the sol-gel on its surface, and then let it dry at 90° C. Re-immerse the non-woven fabric in the active layer sol-gel, take it out after 1 minute and spin off the sol-gel on its surface, and then let it dry at 90° C. Now the non-woven fabric has had two active layers loaded on its surface. Finally, place the non-woven fabric coated with wet TiO₂ sol-gel into a hydrothermal kettle with a mixed solvent of 90% water and 10% ethanol (volume ratio), heat the kettle to 130° C., keep at this temperature for 3 hours, take the fabric out, and then wash and oven-dry. The resultant product is a non-woven fabric substrate surface-load titanium dioxide film photocatalyst.

A photocatalytic property evaluation study has shown that the photocatalyst has high catalytic activity and is capable of reducing the concentration of a formaldehyde gas from 2000 ppm to 300 ppm at the reaction flow rate of 160 ml/min with an 8 W UV lamp as the light source mainly of the 254 nm wavelength.

Thus it can be seen that the flexible substrate surface-load nanocrystalline TiO₂ film photocatalysts made according to the present invention have strong bonding strength, versatility in application, and high photocatalytic effectiveness. In addition, since the materials used in the present methods are inexpensive and the methods themselves are free from undue complexity, the present invention is believed to effectively lower production costs and provide substrates that have much practical value and application.

1. A method of making a photocatalyst by loading titanium dioxide film on a flexible substrate, comprising the steps of:
(1) preparing an active layer sol-gel by:
(a) making a precursor solution comprising n-butyl titanate, ethanol, diethanolamine, and water in the volume ratio of n-butyl titanate ethanol:diethanolamine:water=1:8-12:0.1-0.15:0.05-0.06;
(b) adding a pore-forming agent selected from the group consisting of polyglycol, octadecylamine, and mixtures thereof to the precursor solution of step (1) a), wherein the mass ratio of the amount of the pore-forming agent to the amount of the ethanol in the precursor solution is pore-forming agent:ethanol=1%-30%:1; and
(c) placing the resulting solution in a sealed gelatinization process for at least 3 days; and
(2) preparing an active TiO₂ photocatalyst layer by:
(a) coating a flexible substrate with the active layer sol-gel prepared according to step (1) using a pulling and coating method;
(b) drying the coated flexible substrate; and
(c) placing the coated, dried flexible substrate in a hydrothermal kettle for thermal crystallization in a mixed solvent of ethanol and water at 60-200° C.

2. A method of making a photocatalyst by loading titanium dioxide film on a flexible substrate, comprising the steps of:
(1) preparing an active layer sol-gel by:
a) making a precursor solution comprising titanium tetrachloride, ethanol, and water in the volume ratio of titanium tetrachloride:ethanol:water=1:8-12:0.08-0.15;
(b) adding a pore-forming agent selected from the group consisting of polyglycol, octadecylamine, and mixtures thereof to the precursor solution of step a), wherein the mass ratio of the amount of the pore-forming agent to the amount of the ethanol in the precursor solution is pore-forming agent:ethanol=1%-30%:1; and
c) placing the resulting solution in sealed gelatinization process for at least 3 days; and
2) preparing an active TiO₂ photocatalyst layer by:
(a) coating a flexible substrate with the active layer sol-gel prepared according to step (1) using a pulling and coating method;
(b) drying the coated flexible substrate; and
(c) placing the coated, dried flexible substrate in a hydrothermal kettle for thermal crystallization in a mixed solvent of ethanol and water at 60-200° C.

3. The method according to claim 1 or 2, wherein in the step of preparing said active layer sol-gel further comprises adding an additional agent selected from the group consisting of lanthanum nitrate, n-butyl silicate, and mixtures thereof, to the precursor solution.

4. The method according to claim 3, wherein the molar ratio of lanthanum to titanium is from 0% to about 5%.

5. The method according to claim 4, wherein the molar ratio of lanthanum to titanium is from about 0.8% to about 1.2%.

6. The method according to claim 3, wherein the molar ratio of silica to titanium is from 0% to about 40%.

7. The method according the claim 6, wherein the molar ratio of silica to titanium is from about 15% to about 25%.

8. The method according to claim 1 wherein the ratio of said pore-forming agent to ethanol is from about 8% to about 15%.

9. The method according to claim 1 wherein said flexible substrate is selected from the group consisting of non-woven fabrics, woven fabrics, dust-free papers, water-pricked non-woven fabrics having strong surface hydrophilic property, and mixtures thereof.

10. The method according to claim 1 further comprising the step of removing excess sol-gel by spinning or extrusion, after the step of coating the flexible substrate with the active layer sol-gel prepared according to step (1).

11. The method according to claim 1 wherein the step of drying the coated flexible substrate is carried out at a temperature of from about 30° C. to about 150° C.

12. The method according to claim 11 wherein said drying temperature is from about 80° C. to about 120° C.

13. The method according to claim 1 wherein the ratio of ethanol to water in the mixed solvent of ethanol and water used in the thermal crystallization step is from 0% to about 80%.

14. The method according to claim 13 wherein the ratio of ethanol to water is from 0% to about 20%.

15. The method according to claim 1 wherein said thermal crystallization is carried out at a temperature of from about 120° C. to about 140° C.

16. A photocatalyst prepared by the method according to claim 1.
